(19) United States
(12) Patent Application Publication
(10) Pub. No.: US 2008/0130487 A1
(43) Pub. Date: Jun. 5, 2008

(54) Method For Securing The Communication Links And The Associated Charges In A Redundant Communication Network

(75) Inventor: Klaus Hoffmann, Muenchen (DE)

Correspondence Address: SIEMENS SCHWEIZ AG;I-47, INTELLECTUAL PROPERTY, ALBISRIEDERSTRASSE 245, ZURICH, CH-8047, omitted

(73) Assignee: SIEMENS AKTIENGESELLSCHAFT, Munich (DE)

(21) Appl. No.: 11/792,607

(22) PCT Filed: Dec. 23, 2005
(86) PCT No.: PCT/EP05/13978

§ 371 Date: Jun. 7, 2007

(30) Foreign Application Priority Data
Jan. 24, 2005 (DE) 10 2005 003 195.1
Feb. 18, 2005 (DE) 10 2005 007 419.7

(51) Int. Cl. H04L 12/24

(52) U.S. Cl. 370/216

(57) ABSTRACT

In a method for securing communication links and associated charging in a redundantly configured communication network in which terminals communicate via bearers, and via hardware units by means of messages, a monitoring function is used to monitor a correct functioning of at least one of the terminals, the bearers and the hardware units. If at least one of the hardware units fails, a physical function of a failed hardware unit is taken over by at least one functional hardware unit. After takeover, a message is transmitted by the at least one functional hardware unit to a terminal affected by a failure. The at least one functional hardware unit establishes that the monitoring function is executed by the at least one functional hardware unit. If a transaction is ongoing, a signal from a failed hardware unit is transmitted to a functional hardware unit such that overcharging for the transaction is avoided.

The invention relates to a method for securing the communication links and the associated charging in a redundantly configured communication network in which terminals communicate via bearers, preferably an IP bearer, by means of messages, the correct functioning of the terminals and/or of the hardware units being monitored with a monitoring function and, in the case of a failure of one or more hardware units, the still functional hardware units taking over the physical functions of the failed hardware units.

As a result of the introduction of MGC-MGC communication (media gateway communication=MGC) using inexpensive bearer technology like Internet Protocol (=IP), the communication or bearer channel is through-connected for the communication. MGC-MGC communication is used in cases in which a resolution or a separation of connection establishment, medium establishment or bearer establishment is carried out, i.e. in cases of a resolution or a separation between communication terminal and (data) bearer. Several standardized methods are currently used which, in the case of a resolution or a separation of the connection establishment, attempt to maintain the services in the telecommunication network.

There is currently, for example, the ITU-T standard (=International Telecommunication Union-Telecommunication Standardisation Sector) Q.1902.x Bearer-Independent Call Control Capability Set 2 (=BICC CS2) with-its own display function (=Service Indicator) in the message transfer (=Message Transfer Part; =MTP). Q765.5 Bearer Application Transport (BAT) describes for IP bearers RTP (Real Time Transport Protocol) as bearer technology and how it is possible when separating a call and the bearer to provide the end customer with his customary services in the telecommunication network.

As a further development, RFC 3261 (=Session Initiation Protocol=SIP) and RFC 3204 (ISUP MIME Type) have meanwhile emerged at IETF (Internet Engineering Task Force) as a standard which permits the tunnel transport of ISUP (=ISDN User Part) messages in Session Initiation Protocol messages.

As an additional standard, RFC 2976 (INFO Method) has been adopted which allows ISUP messages to be transported that could not be mapped to the messages defined by RFC 2543 or RFC 3261.

With increasing acceptance of NGN (=Next Generation Network) architecture, solutions in terms of securing the availability of the associated network devices for safeguarding communication services and relating to the provision of secured charging data, including in cases of hardware failure, are becoming increasingly important. The network operators in particular expect the safeguarding of previously known functionalities even in cases of hardware failure of highly centralized hardware devices which provide the signalling protocols between multiple MGCs and corresponding terminals. In addition, failure scenarios in particular which, if the phenomena occurring are not taken into account, will lead to resources “being left hanging” are of considerable significance. This is of significance as network resources will, incorrectly, no longer be available for new allocations, leading to a loss of business for the network operator.

In particular, the Session Initiation Protocol in RFC 3261 sets heightened demands in terms of the securing of a call in order that the data relevant to the call, which as standard are negotiated dynamically when the call is established and will accordingly have to be restored again in the event of a failure, do not go missing in this call. At the same time, however, to control the resources in the network, there also continues to be the requirement that it be ensured in this case, too, that the call itself and the charging are not interrupted and can also correctly be reproduced or released.

At the present time, in communication equipment, e.g. in the applicant's hiE9200, provided no failure has taken place, the other side is monitored in the Session Initiation Protocol on the basis of the Session Timer Draft with the aid of a monitoring function, for example, through re-INVITE with the Session Description Protocol, in order possibly to stop the call and the charging if the other side has failed.

The SDP (=Session Description Protocol) comprises in this case the precise description of the properties of the currently used RTP bearer, for example the IP address, the RTP port, the CODECs used, also designated payload types, the status of the echo canceler, the through-connection status of the bearer, the SDP version counter and more.

This requires, particularly in respect of the two network units involved, such as terminal and data transmitter, that they will also have to restore this Session Description Protocol data in the case of a hardware failure for full support on the replacement hardware. As a result of this, the preventive provision of storage space, in particular, and in addition computer capacity/time or processor time for backing up and for restoring this data on the replacement hardware is necessary in order to support the currently implemented procedure fully. If this industry standard (SIP Session Timer procedure) is not taken into account after a hardware failure, then a stable call would be released unnecessarily if the corresponding call data cannot be restored fully. A stable call is a call which through lifting of the telephone handset achieves the status: “Call answered” and no further feature such as, for example, Call hold is activated. The release of a stable call occurs as a result of the fact that the SDP data or else other call data have been lost and on SIP Session Timer re-INVITE can no longer be answered. Since the Session Description Protocol, in particular, is used in the Session Initiation Protocol for controlling functions like Call Hold, Bearer Redirection, CODEC switchover of the bearer, this signifies the unnecessary provision of storage and computing capacity for a stable call which does not really need this storage and computing capacity.

In RFC 3261 (=Session Initiation Protocol=SIP) a clear separation is introduced between a SIP call process application and the pure SIP transport function. Modern, e.g. software-based, architectures provide for precisely this separation between application and signalling transport, as e.g. in the applicant's hiQ6200 and hiQ9200 communication equipment. In an SMP (simple symmetric processor) architecture, in particular, multiple SIP applications have interfaces to a central SIP transport function or location. Usually, transport function parts are provided by third-party manufacturers (OEM) or a software development unit of the applicant and inserted in the products.

First solutions for saving a stable connection and for forwarding of a correct changing for this stable connection are have been identified and described in practice. Of major importance is the set of problems which accompanies the use of an insulated SIP transport layer. The SIP transport layer keeps record in particular of whether a response to an a message emitted between a network hardware unit (transport part) and a terminal has been received, and, after expiration of a period of time monitored by means of timers, sends the message once again in accordance with RFC3261, chapter 17.1.2.2, if this response is still outstanding. In particular, the SIP application is also informed if the response has completely failed to appear so that further action such as, for example, a release or a different attempt to a different destination etc. is left to the SIP application.

The architecture used and the use of products from third-party manufacturers in relation to the SIP transport layer make it impossible for the network manufacturers—like the applicant—to know structures of the pure SIP function part in sufficient detail in order to restore for this purpose for the transport part a necessary copy—i.e. a copy from the active side to the side that is at this point in time not yet active—of the data on a standby side (in the case of a failure of the entire unit and thus also a failure of the software and of the associated data of the transaction of the transport part). Furthermore, an individual network manufacturer may have no influence on the structure of the transport part in order, for example, to be able to integrate the transport part seamlessly into its own software-based structure and architecture because manufacturers of the transport function for their part offer where possible only one software for all potential network manufacturers. It is thus impossible for the network manufacturer to restore states of the transport part on a redundant hardware unit. Nonetheless, the network manufacturer must guarantee efficient use of his network to the telecommunication service provider, for example in the sense of no resources “being left hanging”.

The basic approach to the detection and further handling of hardware failures and the associated transfer of “call data”-relevant data to a replacement unit is known from the prior art. Only the SIP application-specific and relevant portions are discussed. Normally, a failure of a network unit is adjusted in a simple manner by network operators through “removal” of the failed unit.

Based upon two hardware units in the SIP communication network in which one fails and the other is still functional, the replacement solution of the failed hardware unit by the functional hardware unit remains on a charging level which is highly questionable for the telecommunication service provider or for the user of a terminal in connection with at least one of the two hardware units. If in the case of an unstable call a transaction is also outstanding when the failure occurs, unwanted surcharges can arise e.g. if a charging message is lost.

The object of the invention is therefore to provide a method for securing communication links and the associated charging in a communication network for linking terminals, preferably in a SIP communication network, which method will provide in the case of a hardware failure the customary communication services but which, compared with the previously known standardized backup methods, can be implemented more simply and with substantially less storage and computing capacity. At the same time as the hardware failure, where an ongoing transaction is released e.g. by a failed unit or simply has to be taken into account there, surcharges for said transaction should be avoided.

This object is achieved in the features of the independent claim 1. Advantageous further developments of the invention are the subject matter of subordinate claims.

The inventor has recognised that in the RFC3261 standard with Session Initiation Protocol and in RFC3264 with Session Description Protocol offer/answer and the SIP session draft (=Session Timers in the Session Initiation Protocol=draft-ietf-sp-session-timer-13), the facility for monitoring the other SIP side is available. In Section 7.4 of: “Generating Subsequent Session Refresh Requests of the SIP session draft”, use of the UPDATE method in RFC3311 is enabled without using the Session Description Protocol (SDP:RFC2327). Source: http://www.ietf.org/internet-fdrafts/draft-ietf-sip-session-timer-15.txt, the content of this Web page being incorporated fully into this application.

Accordingly, the inventor proposes improving the known method for securing the communication links and the associated charging in a redundantly configured communication network in which terminals communicate via bearers, preferably an IP bearer, and via hardware units by means of messages, the correct functioning of the terminals and/or of the bearer (2) and/or of the hardware units being monitored with a monitoring function, and in the case of a failure of one or more hardware units the still functional hardware units taking over the physical functions of the failed hardware units, such that immediately after taking over the physical functions, the functional hardware units transmit a message to the terminals involved and additionally establish that the monitoring function is executed by the still functional hardware units. Furthermore, in the case of an ongoing transaction (in the case of unstable calls), a signal from one or more of the failed hardware units is transmitted to one or more of the functional hardware units such that surcharges for said transaction are avoided.

This achieves the outcome that in the case of a failure of one or more hardware units, the existing communication links or communication links to be re-established and the associated charging in a communication network, preferably a SIP communication network, continue to function properly and the customary communication services are still available to the communication subscribers.

The redundantly configured communication network may be a SIP communication network and the messages transmitted SIP messages.

The previously necessary restoration of the affected call data in the case of a (hardware) failure, for example via the Session Description Protocol, together with the accompanying necessary use of storage and computing capacity, can be avoided through use of the new method.

It is advantageous for the method if the terminals which receive a message from the functional hardware units, send a response back to said hardware units. For example, the SIP terminal involved can send a 200 OK as a response to the UPDATE. By this means, it can be established in a simple manner whether the existing communication link is actually affected by the failure of the hardware unit.

Furthermore, it is advantageous if the terminals and/or the hardware units are monitored by a SIP Session Timer (Session Timer in the Session Initiation Protocol). By this means, a simple method of monitoring the SIP communication devices involved is available in the SIP system.

The SIP Session Timer monitoring function can establish whether the terminals involved or the hardware components send or receive an INVITE or UPDATE message, the UPDATE message being used without SDP. In this way, the role of the SIP endpoint is established. This is particularly advantageous since by this means the other side now no longer has to send a re-INVITE with the Session Description Protocol which would then as standard in turn have to be answered in the reply to the re-INVITE with the no longer necessarily present Session Description Protocol with all its aspects. The outlay on establishing the connection of the new hardware unit with the previous terminal, after the takeover of the functions of the failed hardware unit, is therefore kept lower in the new method than previously.

In one embodiment of the method, the charging is executed by a SIP proxy, preferably a proxy server. In the case of a failure of the SIP proxy, the message UPDATE can for security reasons after the takeover of the physical functions by the functional hardware units be sent to both communicating terminals, so that the call is not released. The side which is waiting to receive the periodic re-INVITE/UPDATE, releases the call when the message has been received.

In the new method, the charging can, depending on the response of the terminals, be implemented further or stopped if no response comes from the terminals. If, for example, a functional hardware unit's message to the terminal involved is answered with a negative response, then it can be concluded therefrom that this side is still operating and the call and the charging can continue to run.

In summary, stable and unstable calls and their charging are recognised clearly, correctly and without loss in the case of a hardware failure, and appropriate measures (release of the call, termination of the charging, etc.) introduced.

The invention is described in detail below with reference to preferred exemplary embodiments with the aid of figures, whereby it is pointed out that only the elements essential for immediate understanding of the invention are shown. The following reference characters are used here:

1: SIP communication network; 2: IP bearer/transmitter; 3: telecommunication installation/hiG1000; 4: TX (=transit exchange); 5: LE (=local exchange); 6: PSTN (=public switched telephone network); 7.1-7.x: communication terminal/telephone; 8: media node/hiQ9200; 9: CMN call mediation node from BICC ITU-T Q.1901; 10: SIP proxy; 11: SIP terminal; 12: computer; 13: transfer of SIP messages; 14: first hardware unit; 14.1: failure of first hardware unit; 15: second hardware unit; 16: redundant link of first and second hardware unit; 17: message/UPDATE; 18: response to message UPDATE/200 OK.

In detail:

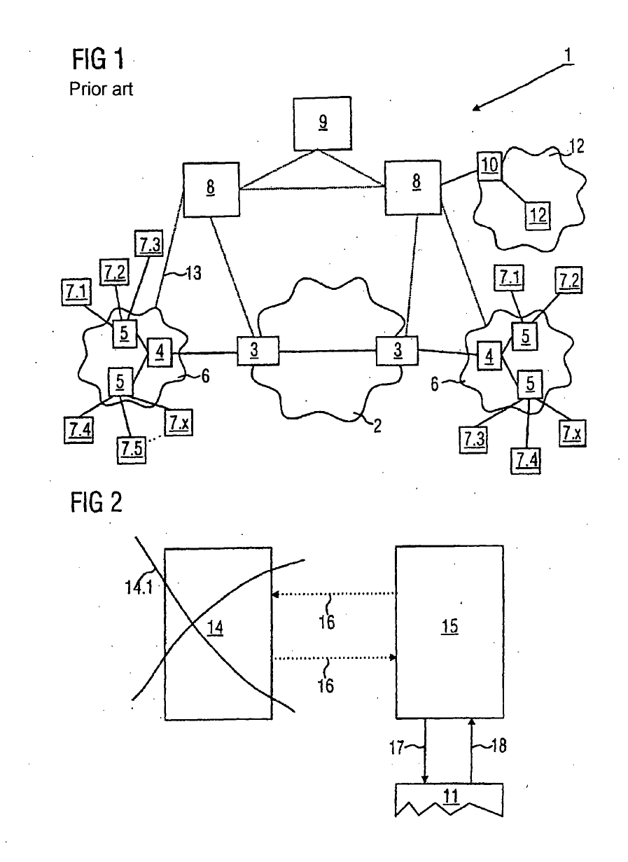

FIG. 1 shows a schematic configuration of a SIP communication network,

FIG. 2 shows a schematic diagram which shows the failure of a hardware unit and the subsequent steps in the new method.

FIG. 1 shows a schematic configuration of a SIP communication network 1. In this SIP communication network 1, communication terminals 7.1-7.x, preferably simple telephones, are connected to one another via a bearer, here an IP bearer 2. The communication terminals 7.1-7.x are connected to public switched telephone networks 6. However, computers 12 can also communicate with one another via this SIP communication network 1 and the transfer of SIP messages 13 taking place therein. The inventive idea also covers networks in which SIP terminals are connected directly to a SIP proxy in a pure SIP domain with no public switched telephone network PSTN 6.

The network operator would also like to ensure in the case of failure of one or more hardware units of the SIP communication network 1 that firstly the charging for the existing communication links can be accounted for correctly and can continue to run. Secondly, despite the failure, the customary services should be available without delay to the users of the SIP communication network. To this end, a new and simple method is presented which enables the securing of the communication links and the associated charging in a SIP communication network.

FIG. 2 shows a schematic diagram in which a failure 14.1 of a hardware unit, here the first hardware unit 14, is represented, which could be located e.g. in FIG. 1 toward the outside as a unit inside the units 8 or 9, which are linked for example via the SIP protocol (the MGCP could run e.g. between the units 8 and 3). The failure 14.1 of the first hardware unit 14 is represented by the X symbol. Furthermore, FIG. 2 represents schematically how the second hardware unit 15 takes over the tasks of the failed first hardware unit 14 and what steps are initiated in the new method to this end.

In a communication network, the hardware units 14 and 15 have for security reasons a redundant link 16 with one another so as to enable a takeover of the function of the failed hardware unit 14 by the still functional hardware unit 15. In the process, the signal—e.g. a piece of information about the status of the transaction—is transmitted in the case of an ongoing transaction (i.e. in the case of an unstable call, e.g. relative to one of the terminals 7.1-7.x, 11, 12 or to any transaction-releasing failed unit (bearer, hardware unit, cookies server, etc.) and for which call the transaction is now reported to the functional hardware unit 15) from the failed hardware unit 14 to the functional hardware units 15 (the signal is transported so-to-speak internally from one unit 14 to the other unit 15 (not visible from outside) such that surcharges for this transaction are avoided. The functional hardware unit 15 is thus aware that there is still an outstanding transaction in relation to a call. With the transfer to the functional hardware unit 15, the call is preventively released as a transaction has been started on the failed hardware unit 14. The response thereto does not, however, come to the application in the functional hardware unit 15 since the necessary data is not available in the transport part. To sum up, in this case—where there is an ongoing transaction—an unstable SIP call is monitored and released and the charging terminated.

Methods and procedures for detecting hardware failures and the further handling of hardware failures or the associated transfer of relevant data to the replacement hardware unit are already known from the prior art. In the new method, the portions relevant to the Session Initiation Protocol (=SIP) are preferably used.

In the case of a failure 14.1 of the first hardware unit 14, in accordance with the redundant configuration of the communication network, the second hardware unit 15 will take over the function of the first hardware unit 14. Previously the first hardware unit 14 had been connected to a SIP terminal 11, for example a telephone and/or a computer. The connection of the first hardware unit 14 to the SIP terminal 11 is not shown in FIG. 2. After failure 14.1 of the first hardware unit 14, the second hardware unit 15 will be connected to the SIP terminal 11 and will communicate with said SIP terminal.

After the takeover of the physical function(s) of the first hardware unit 14, the second hardware unit 15 sends in the new method a message 17 to the SIP terminal 11, here a SIP UPDATE. The SIP UPDATE is a SIP message or a possible method which is defined in RFC3311 and is not excluded in the SIP Session Timer draft, which can display a change of the SIP call without using the Session Description Protocol of the communication network. The message 17 can contain the additional stipulation that the SIP Session Timer monitoring function be implemented with immediate effect from here, i.e. from the second hardware unit 15.

The SIP Session Timer monitoring function can stipulate which of the two elements involved, i.e. the second hardware unit 15 or the SIP terminal 11 should send the messages INVITE or UPDATE, to ascertain the readiness and presence of the other side. The message INVITE is on the one hand a SIP message which can establish a connection or on the other hand it makes it possible as re-INVITE for an existing stable connection to change the connection data. It can also be used for the SIP Session Timer procedure.

Thus, the stipulation that the second hardware unit 15 will be the new communication partner of the SIP terminal 11 can now be stipulated by the second hardware unit 15 independently of the previous history on the first hardware unit 14. This is particularly advantageous since by this means the other side can now no longer send a re-INVITE with the Session Description Protocol which would then in turn have to be answered as standard with the no longer necessarily present Session Description Protocol with all its aspects in the response 18, here a 200 OK to the re-INVITE.

According to the invention, the SIP partner 11 that receives the message 17, here an UPDATE, responds with a response 18, here a 200 OK. This is, in accordance with RFC3261 SIP, the standard positive response to a SIP message, here positive response to UPDATE. In this way, both the second hardware unit 15 and the SIP terminal 11 know that the call or the connection is OK and that the charging and the call do not need to be terminated. This is in particular the case because, in spite of failure 14.1 of the first hardware unit 14 which provides only the SIP signalling, the associated communication network is very probably still functional, and the communication subscribers can still talk or communicate with one another, and the failure 14.1 of the first hardware unit 15 has no impact.

If the other side answers the message/UPDATE 17 contrary to. expectations with a negative response 18, the second hardware unit 2 will/can evaluate this reaction as a confirmation according to which the other side is nevertheless still functional, and the call and the charging can continue to run.

In the case of failure of a SIP proxy which, for example, undertakes the charging, then, according to the invention, the sending of the UPDATE has to be carried out to both sides of the connection.

It should be noted in particular that the solution proposed for SIP can also be translated for the protocols MGCP (as per RFC2705) and MEGACO (ITU-T H.248) since fundamentally the same set of problems occurs there.

The features cited hereinabove can of course be used not only in the combination specified in each case, but also in other combinations or alone, without departing from the scope of the invention.

The following abbreviations have been used:
BAT Bearer Application Transport
BICC Bearer Independent Call Control
CMN Call Mediation Node
CODEC Coding Decoding
IETF Internet Engineering Task Force
IP Internet Protocol
ISDN Integrated Services Digital Network
ISUP ISDN User Part
ITU-T International Telecommunication Union-Telecommunication Standardisation Sector
LE Local Exchange
MG Media Gateway
MGC Media Gateway Communication
MTP Message Transfer Protocol
NGN Next Generation Network
PSTN Public Switched Telecommunication Network
RFC Request for Comments
RTP Real Time Transport Protocol
SIP Session Initiation Protocol
SDP Session Description Protocol
TX Transit Exchange

1.-8. (canceled)

9. A method for securing communication links and associated charging in a redundantly configured communication network in which terminals communicate via bearers, and via hardware units by means of messages, comprising:
using a monitoring function to monitor a correct functioning of at least one of the terminals, the bearers and the hardware units;
in case of a failure of at least one of the hardware units, taking over of a physical function of a failed hardware unit by at least one functional hardware unit;
after taking over a physical function, transmitting a message by the at least one functional hardware unit to a terminal affected by a failure;
establishing by the at least one functional hardware unit that the monitoring function is executed by the at least one functional hardware unit; and
in case of an ongoing transaction, transmitting a signal from a failed hardware unit to the at least one functional hardware unit such that overcharging for said transaction is avoided.

10. The method of claim 9, wherein a SIP communication network is deployed as a redundantly configured communication network and SIP messages are transmitted as messages.

11. The method of claim 9, wherein a terminal which receives a message from a functional hardware unit sends back a response to said functional hardware unit.

12. The method of claim 9, wherein at least one of the terminals and the hardware units are monitored by a SIP session timer.

13. The method of claim 12, wherein a SIP session timer monitoring function establishes whether at least one of the terminal and the hardware unit affected by the failure sends or receives an INVITE or UPDATE message, wherein the UPDATE message is used without a session description protocol.

14. The method of claim 9, wherein a charging is executed by a SIP proxy and, in case of failure of the SIP proxy, the message is sent to both communicating terminals.

15. The method of claim 14, wherein depending on a response of the terminals, the charging is implemented further or is terminated if no response came or the call is terminated.

16. The method of claim 9, wherein in case of an ongoing transaction with one of the terminals a call is released via a failed unit and a corresponding charging is stopped.
